(19) United States
(12) Patent Application Publication
(10) Pub. No.: US 2004/0111695 A1
(43) Pub. Date: Jun. 10, 2004

(54) Apparatus for aiding in generating a source code

(76) Inventor: Takaichi Kato, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/724,720

(22) Filed: Dec. 2, 2003

(30) Foreign Application Priority Data
Dec. 6, 2002 (JP) 2002-383083
Nov. 11, 2003 (JP) 2003-381404

(51) Int. Cl. G06F 9/44

(52) U.S. Cl. 717/100

(57) ABSTRACT

When a necessary command term in a template indicated at the display in the apparatus for aiding in generating a source code is selected and a necessary parameter is input in an input area, the template indicates a source code the user desires to generate in a natural language. If a determiner determines that the necessary command term in the template has been selected and the necessary parameter has been input, a generator generates a source code corresponding to the statement in the natural language indicated in the template. The generated source code is displayed at a display. Therefor the apparatus can readily generate a source code based on an input or selected statement expressed in a natural language in a single display screen image.

### BACKGROUND OF THE INVENTION

1. Field of the Invention

The present invention relates to an apparatus that aids in generating programs, and more specifically, to an apparatus that aids in producing sequence control programs.

2. Description of the Related Art

A Programmable Logic Controller (PLC) is used for controlling mechanical equipment in factories and the like, while the user of the equipment (such as an operator and a maintenance engineer) produces a sequence control program that describes the sequence of operation by the equipment and stores the sequence control program in the PLC. The mechanical equipment operates according to the sequence control program in the PLC.

Such programs for the PLC are often produced by a ladder method using a ladder diagram. The ladder method is however a method developed for people well acquainted with and experienced in the operation by sequence control, and therefore a user whose specialty is in the machine equipment rather than the sequence control cannot produce programs by the ladder method as well as the user desires to.

The invention directed to this problem is disclosed by Japanese Patent Laid-Open No. 2000-163107. According to the disclosure of the document, a program for a PLC is produced using a flowchart, and steps (command processing) in the flowchart are produced sequentially according to instructions displayed on the screen of a display for a computer. Therefore, the disclosed method does not require special knowledge unlike the ladder method.

However, according to the invention disclosed by the document, the screen image at the display must be changed a number of times to produce a single step, and conditions for producing the step must be selected or input in each of the screen images. The user must have some previous knowledge of the flowchart. Consequently, it would be preferable if the user can produce a program (source code) from a natural language.

Furthermore, the user must use special dictionaries to check up and understand the content of a plurality of statements forming a source code produced according to the ladder method or the flowchart method, which is rather cumbersome and complicated. Consequently, it is not easy for the user to acquire knowledge of the source code.

### SUMMARY OF THE INVENTION

It is an object of the invention to provide an apparatus that can readily generate a source code based on a selected or input statement expressed in a natural language in a single display screen image.

Another object of the invention is to provide an apparatus that allows the meaning of the content of a source code to be readily understood.

An apparatus according to the invention aids in generating a source code including a plurality of statements and includes a storage device storing a plurality of templates corresponding to the plurality of statements. The plurality of templates each include a selection area, a plurality of input areas, and a command button. In the selection area, a plurality of command terms for generating the statement are indicated in a natural language. The input area is provided with a parameter for generating the statement. The command button is selected by the user in generating the source code for the statement. The apparatus further includes a display, determiner, and generator. The display displays a template selected by the user among the plurality of templates. The determiner determines whether or not a command term necessary for generating a desired statement has been selected in the selection area and a necessary parameter for generating the desired statement has been input to the input area by the user when the command button in the displayed template is selected by the user. When the determiner determines that the necessary command term has been selected and the necessary parameter has been input, the generator generates a source code for the desired statement based on the selected command term and the input parameter. The display displays the source code generated by the generator.

The apparatus according to the invention has a plurality of templates, each of which indicates a plurality of command terms in its selection area in a natural language. The user can readily select a command term corresponding to a desired statement among the plurality of command terms in the natural language using a template in order to generate a source code for the desired statement. Therefore, the user with little knowledge of source codes can readily produce a source code using the apparatus. In addition, the user can produce a desired statement using a template displayed at the display, so that the screen image displayed at the display does not have to be changed a number of times in order to produce a single statement.

Furthermore, the apparatus determines whether or not the user has selected a necessary command term for generating a desired statement and input a necessary parameter for generating the desired statement in an input area. The apparatus does not generate a source code if the necessary command term has not been selected or if the necessary parameter has not been input to the input area. In this way, the user can readily confirm if the user has selected a necessary term for producing a statement or if a necessary input has been made.

Preferably, the plurality of input areas correspond to the plurality of command terms, and the determiner determines whether or not a parameter has been input to the input area corresponding to the selected command term.

At the time, the determiner can determine whether or not a necessary parameter for generating a statement has been input to the input area.

More preferably, the apparatus further includes a communicator. The communicator notifies the user of the need to input a parameter to the input area corresponding to a command term selected among a plurality of command terms in the selection area.

In this way, the user can readily recognize an input area that should be provided with an input for producing the statement.

Preferably, the plurality of statements include a plurality of command codes, the plurality of command terms correspond to the plurality of command codes, and the storage device further stores a translation table having the plurality of command codes corresponding to the plurality of templates. The apparatus further includes template selector, term selector, and parameter provider. The template selector selects the template corresponding to the command code in the statement selected in the source code displayed at the display based on the translation table. The term selector selects a command term corresponding to the command code in the selection area in the selected template.

The parameter provider provides a parameter in the selected statement to the input area corresponding to the selected command term. After the term selector selects the command term, and the parameter provider provides the parameter, the display displays the template selected by the template selector.

At the time, the apparatus selects a template corresponding to the command code in the selected statement. The apparatus further selects a command term corresponding to a command code in the selected template, provides a parameter in the statement to an input area corresponding to the selected command term and then displays the template at the display. In the displayed template, a natural language statement corresponding to the statement (source code) is indicated. Consequently, the user can understand the meaning of the content of the source code based on the natural language statement.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a functional block diagram of the configuration of an apparatus according to a first embodiment of the invention;

FIG. 2 is a view showing an example of a template stored in the storage device shown in FIG. 1;

FIG. 3 is a functional block diagram of the configuration of a typical computer;

FIG. 4 is a flowchart for use in illustration of the translation operation of the apparatus shown in FIG. 1;

FIG. 5 is a view of a screen image displayed at a display in step S1 in FIG. 4;

FIG. 6 is a view of a screen image displayed at the display in step S2 in FIG. 4;

FIG. 7 is a view of an example of a template after the user selects a command term and inputs a parameter;

FIG. 8 is a view of a screen image displayed at the display in step S7 in FIG. 4;

FIG. 9 is a flowchart for use in detailed illustration of the operation in step S3 in FIG. 4;

FIG. 10 is a flowchart for use in detailed illustration of the operation in step S5 in FIG. 4;

FIG. 11 is a diagram of the configuration of an apparatus according to a second embodiment of the invention;

FIG. 12 is a view of a screen image in which a source code to be subjected to inverse translation is displayed;

FIG. 13 is a flowchart for use in illustration of the inverse translation of the apparatus shown in FIG. 10;

FIG. 14 is a view of an example of a template selected in step S402 in FIG. 12; and

FIG. 15 is a view of a screen image displayed at the display in step S406 in FIG. 12.

### DETAILED DESCRIPTION OF THE PREFERRED EMBODIMENTS

Now, embodiments of the invention will be described in detail in conjunction with the accompanying drawings. The same or corresponding portions among the drawings are denoted by the same reference numerals and characters and will not repeatedly be described.

1. First Embodiment

1.1. Configuration of Apparatus

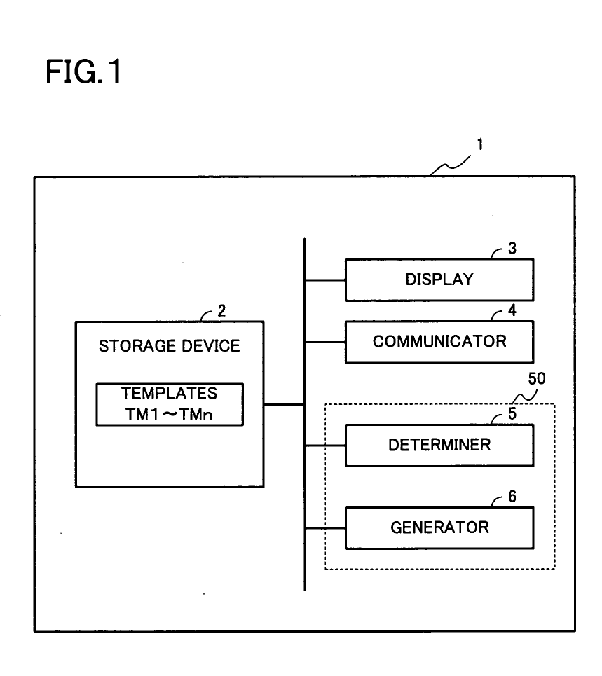

Referring to FIG. 1, an apparatus 1 includes a storage device 2, a display 3, a communicator 4, and a translation unit 50.

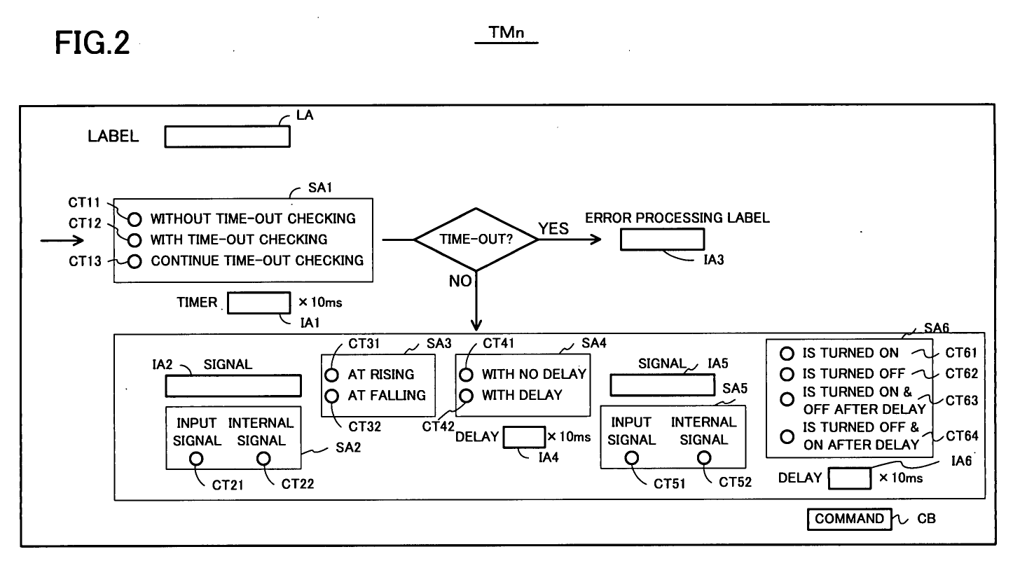

The storage device 2 stores a plurality of templates TM1 to TMn (n: natural number). The plurality of templates TM1 to TMn are used to generate a plurality of statements forming a source code. An example of the template TMn is shown in FIG. 2.

Referring to FIG. 2, the template TMn includes a label area LA, a plurality of selection areas SA1 to SA6, a plurality of input areas IA1 to IA6, and a command button CB.

The label name of the statement generated in the template TMn is input in the label area LA. The plurality of selection areas SA1 to SA6 each include command terms CT necessary for generating a statement desired by the user. For example, the selection area SA1 in FIG. 2 includes a command term CT11 for “without time-out checking,” a command term CT12 for “with time-out checking,” and a command term CT13 for “continue time-out checking.” The command terms CT each have an option button, and an option button corresponding to a command term CT to be selected is selected.

The plurality of input areas IA1 to IA6 are provided with parameters necessary for generating a statement desired by the user. The plurality of input areas IA1 to IA6 correspond to a plurality of command terms CT in the plurality of selection areas SA1 to SA6. More specifically, an input area IA to be provided with a parameter is determined based on a selected command term CT. For example, when the command CT12 for “with time-out checking” in the selection area SA1 is selected, a parameter is to be input to the input areas IA1 and IA3. Note that the input area IA1 is provided with time for checking as a parameter. The label of another program is input as a parameter to the input area IA3 when time-out occurs as a result of time-out checking.

When a command term CT42 for “after delay” in a selection area SA4 is selected, the input area IA4 is determined as an input area to be provided with a parameter. The delay time is input to the input area IA4 as the parameter.

The user selects a necessary command term CT in a template TMn, inputs a necessary parameter to an input area IA corresponding to the selected command term CT, and then selects the command button CB. In this way, the apparatus generates a source code based on the content of the template TMn.

Referring back to FIG. 1, the display 3 displays a template TMn selected by the user among the plurality of templates TM1 to TMn. The display 3 also displays a source code generated based on the template TMn selected by the user.

The communicator 4 notifies the user of the need to input a parameter to an input area IA corresponding to a prescribed command term CT selected in the selection area SA in the template TMn selected by the user. The notification is carried out by audio sounds, making the input area to be provided with an input flash on and off or the like. For example, when the command term CT42 in the selection area SA4 in FIG. 2 is selected, the communicator 4 makes the input area IA4 flash on and off. The communicator 4 also notifies the user of the selection area SA from which the user should select a command term CT.

The translation unit 50 includes a determiner 5 and a generator 6. When the user selects the command button CB in the template TMn displayed at the display 3, the determiner 5 determines whether or not the user has selected a command term CT necessary for generating a desired statement in the plurality of selection areas SA1 to SA6 in the template TMn, and input a parameter necessary for generating the desired statement to an input area IA.

When the determiner 5 determines that the necessary command term CT has been selected, and that the necessary parameter has been input, the generator 6 generates a source code based on the selected command term CT and the input parameter.

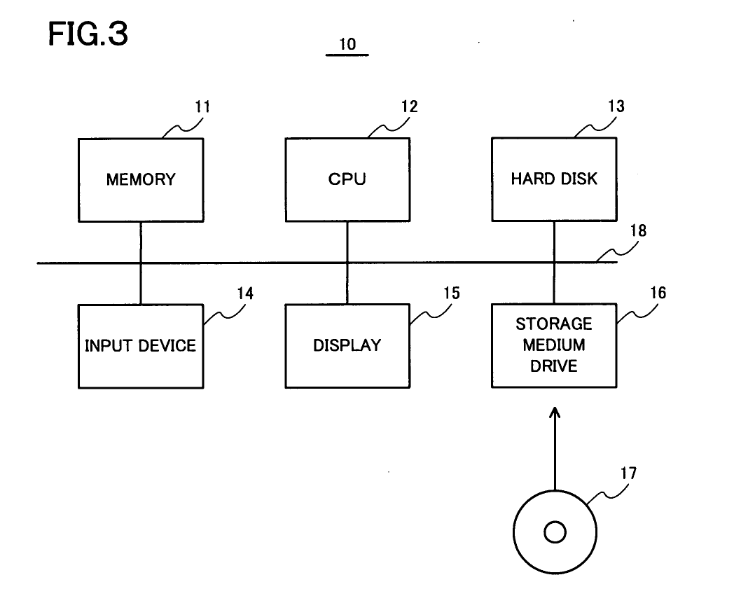

FIG. 3 is a functional block diagram of the general configuration of a typical computer. Referring to FIG. 3, the computer 10 includes a memory 11, a CPU (Central Processing Unit) 12, a hard disk 13, an input device 14, a display 15, and a storage medium drive 16. The bus 18 connects them with each other.

The memory 11 is a volatile or non-volatile semiconductor memory device, and can be for example any of a ROM (Read Only Memory), a RAM (Random Access Memory), and a flash memory. The input device 14 is for example a keyboard or a mouse. The storage medium drive 16 reads/writes data from/to a storage medium 17 such as a flexible disk, a CD-ROM, and an MO. The storage medium 17 stores a source code producing aiding program for aiding in generating a source code. In FIG. 3, a CD-ROM is shown as a typical example of the storage medium 17, but the medium may be a flexible disk or an MO. The computer 10 has the program for aiding in generating a source code in the storage medium 17 installed and then serves as the apparatus 1.

Note that in comparison between FIGS. 1 and 3, the storage device 2 in FIG. 1 corresponds to the memory 11 and the hard disk 13 in FIG. 3. The display 3 in FIG. 1 corresponds to the display 15 in FIG. 3. The communicator 4 and the translation unit 50 in FIG. 1 correspond to the CPU 12 in FIG. 3.

1.2. Translation Operation

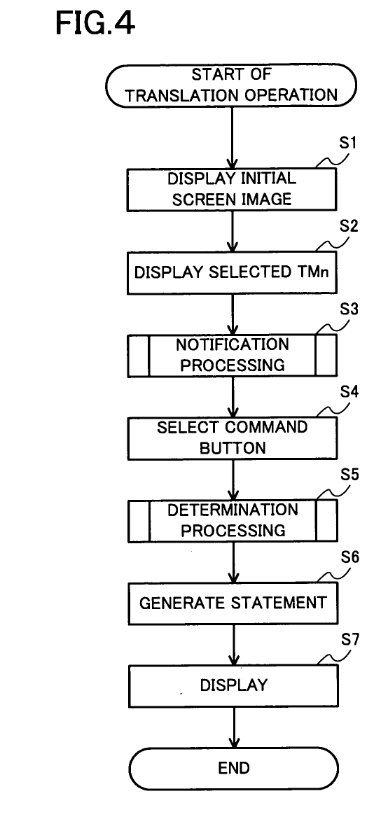

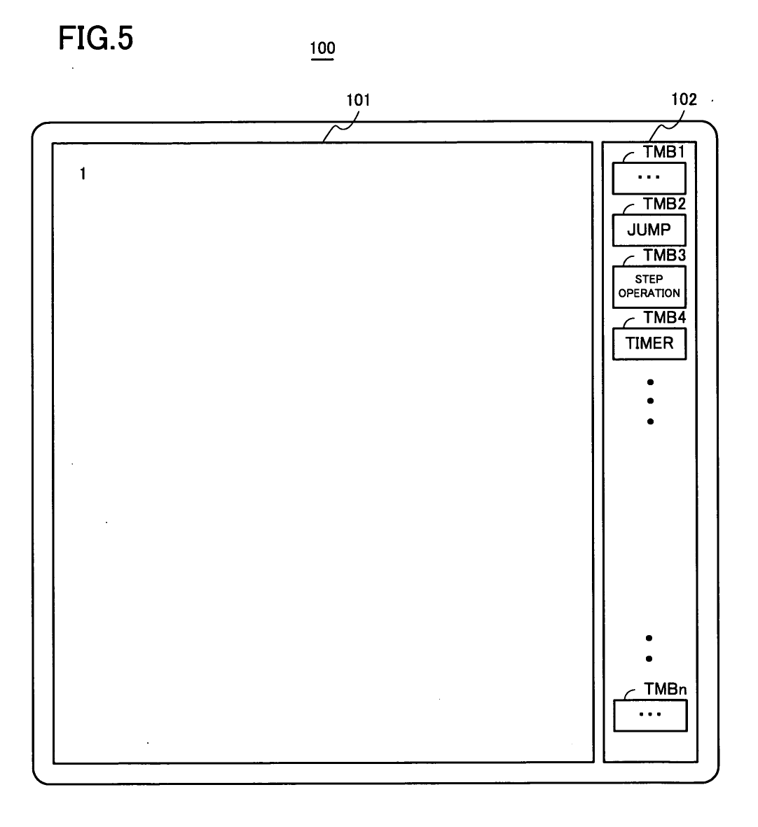

Referring to FIG. 4, the display 3 in the apparatus 1 displays an initial screen image (S1). An example of the initial screen image is shown in FIG. 5. The screen image 100 includes a source code display area 101 and a template selection area 102. The template selection area 102 includes a plurality of template selection buttons TMB1 to TMBn corresponding to the plurality of templates TM1 to TMn. The template selection buttons TMBn each display a term. For example, the template selection button TMB2 displays a term “jump.” The template selection button TMB2 corresponds to the template TM2 for producing a statement content that controls the program flow to jump to a task with a prescribe label depending on a condition. The template selection button TMB3 displays “step operation.” The template selection button TMB3 corresponds to the template TM3 that produces a statement for a series of steps at a time. The user refers to terms in template selection buttons TMBn and selects a template selection button TBMn corresponding to a desired template TMn.

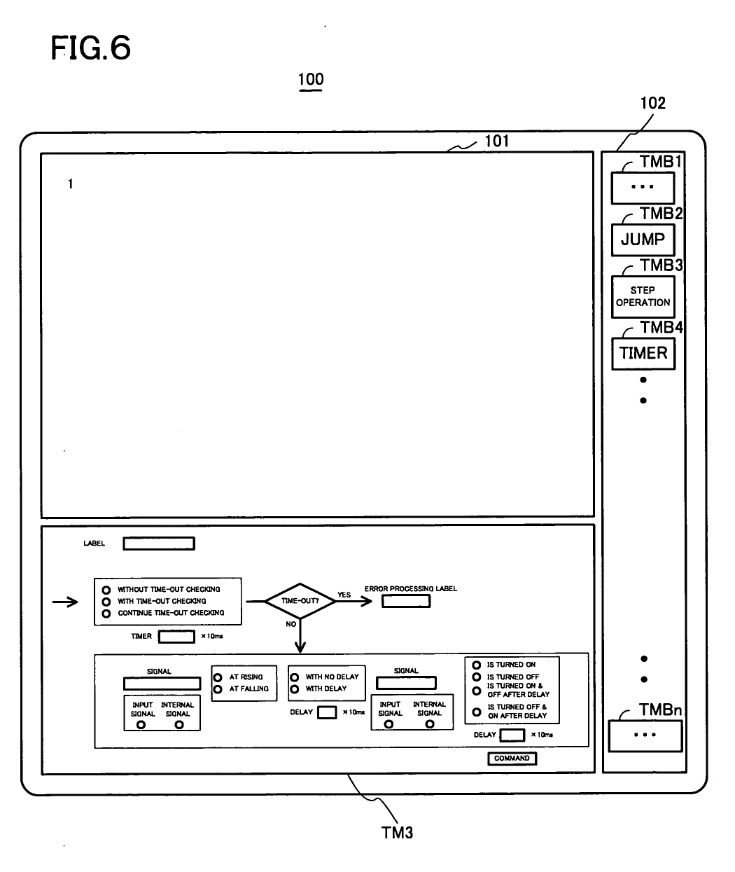

When the user selects the template selection button TMB3, the apparatus 1 displays the template TM3 at the display 3 (S2). The screen image displayed at the display 3 in step S2 is shown in FIG. 6. The template TM3 is displayed in the lower part of the screen image 100. The template TM3 is the same as that in FIG. 2.

The user then selects a command term CT necessary for generating a statement that forms a source code, and inputs a parameter. At the time, the communicator 4 carries out notification processing (S3). More specifically, the communicator 4 makes an input area IA that should be provided with an input flash on and off based on the command term CT selected by the user in order to urge the user to provide an input (S3). At the time, the communicator 4 also makes a selection area SA that should be selected by the user flash on and off.

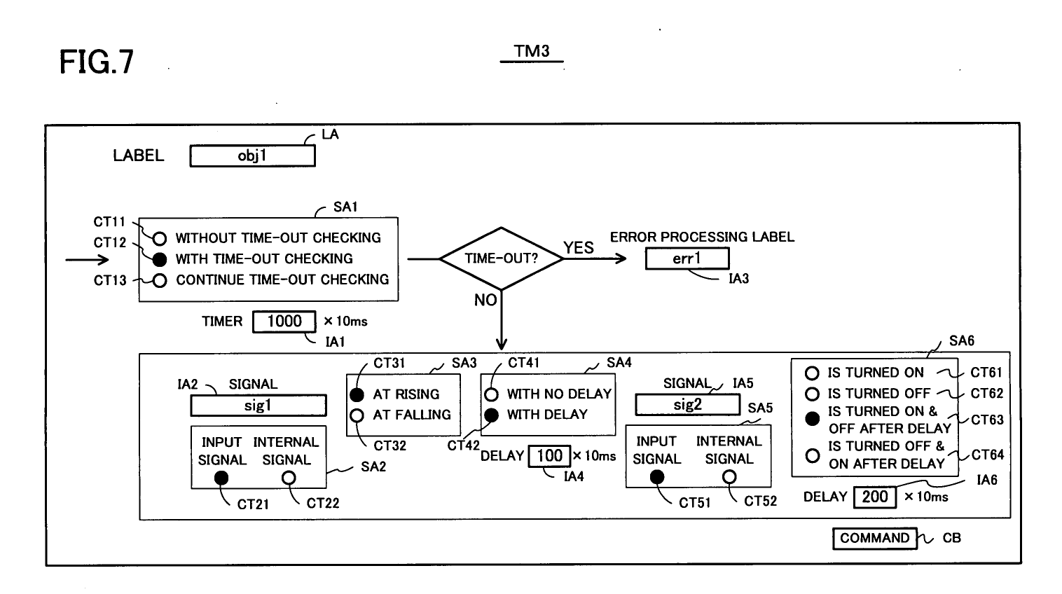

In the template TM3 for which the user has selected a necessary command term CT and input a parameter, a statement desired by the user is indicated in a natural language. FIG. 7 shows an example of the template TM3 for which the user has selected a necessary command term CT and input a parameter. In the region 103 in FIG. 7, the content of the statement desired by the user is that “after a delay” “of 100×10 ms” “at the rising of” “an input signal sig1,” “an output signal sig2” “is turned ON and then OFF after a delay of 200×10 ms.” Therefore, using the template TMn, the user with little knowledge of the ladder diagram or flowchart can easily produce a source code from a natural language.

After the user selects a necessary command term CT and inputs a necessary parameter in response to the notification by the communicator 4, the user selects a selection button CB (S4). At the time, the determiner 5 carries out determination processing (S5). The determiner 5 determines whether or not the user has selected a command term CT necessary for generating a desired statement in the plurality of selection areas SA1 to SA6 in the template TM3 and input a parameter necessary for generating the desired statement in the input area IA.

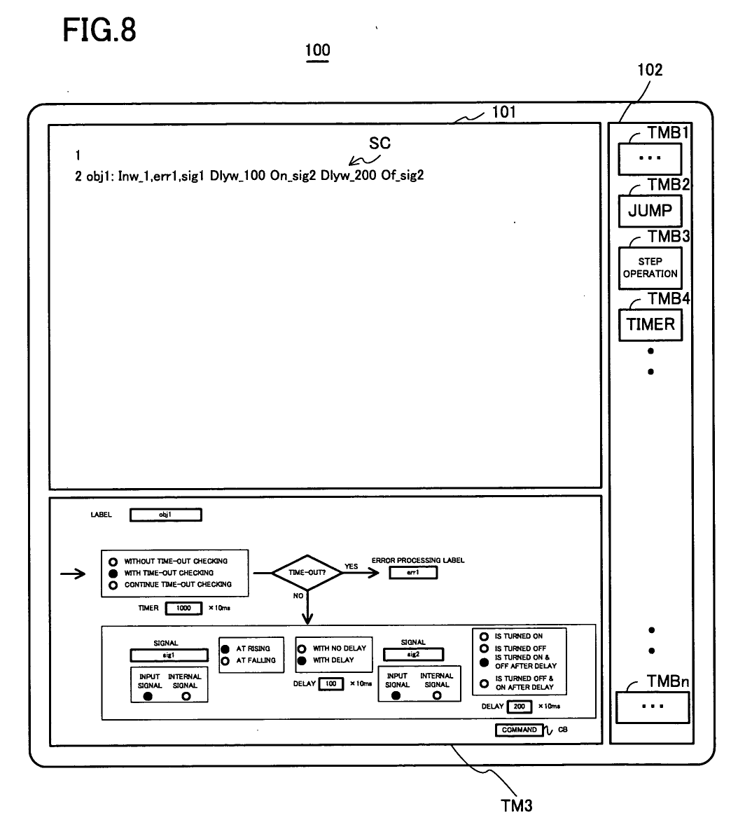

When the determiner 5 determines that the user has selected the necessary command term CT and input the necessary parameter in the input area IA, the generator 6 generates a source code SC for a statement based on the content of the template TM3 (S6). More specifically, the command term CT selected by the determiner 5 is specified, and the parameter input to the input area IA is specified, so that the generator 6 generates a source code using a command code corresponding to the specified command term CT and the specified parameter. The generated source code SC is displayed in a source code display area 101 at the display 3 as shown in FIGS. 8 (S7). Note that the template TM3 in FIG. 8 is the same as that in FIG. 7.

The user can produce a desired statement in the template TM3 displayed at the display 3. More specifically, a plurality of command terms are selected in the template TM3, and necessary parameters are input, so that the user can produce a statement in a natural language in the template TM3. The apparatus 1 translates the statement in the natural language displayed at the template TM3 into a source code. Consequently, the user with little knowledge of source codes can easily produce a source code simply by producing a statement in a natural language.

It is not necessary to display different templates TMn at the display 3 in order to generate a single source code. Therefore, the operation of generating a source code is easy and not so cumbersome and complicated.

By the above described operation, the apparatus 1 carries out translation operation. Now, the notification processing in step S3 and the determination processing in step S5 will be described in detail.

Notification Processing

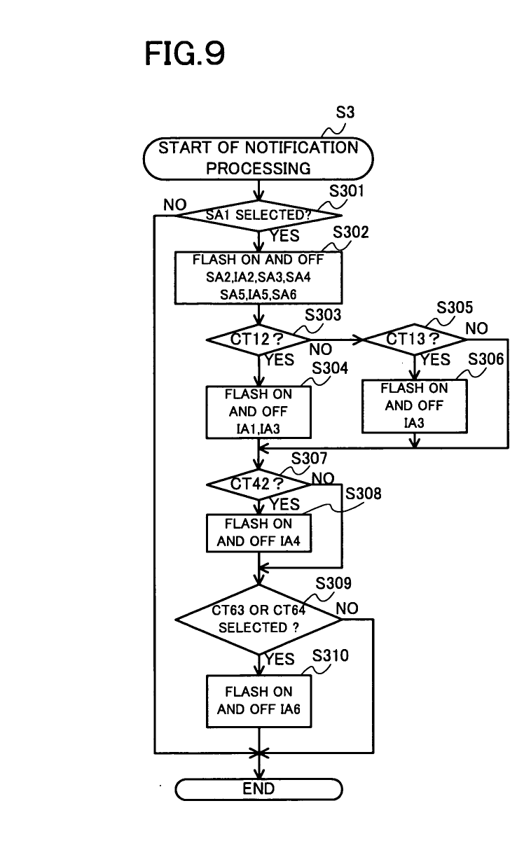

Referring to FIG. 9, when the user selects any of the command terms CT11 to CT13 in the selection area SA1 in the template TM3 (S301), a selection area SA that should be selected by the user and an input area IA that should be provided with an input by the user are made to flash on and off in the template TM3 by the communicator 4.

More specifically, the communicator 4 makes the selection areas SA2 to SA6 and the input areas IA2 and IA5 flash on and off (S302). The input area IA2 is made to flash on and off because the user must input a parameter in the input area IA2 regardless of which command term CT (CT21 or CT22) in the selection area SA2 corresponding to the input area IA2 is selected. The input area IA5 is made to flash on and off in step S302 for the same reason.

Then, it is determined which command term CT in the selection area SA1 has been selected by the user (S303, S305). When the user selects the command term CT12 (S303), the input areas IA1 and IA3 that should be provided with a parameter, i.e., the areas corresponding to the command term CT12 are made to flash on and off by the communicator 4 (S304). When the user selects the command term CT13 (S305), the input area IA3 corresponding to the command term CT13 is made to flash on and off by the communicator 4 (S306). When the user selects the command term CT11, not the command terms CT12 and CT13, there is no necessity for inputting a parameter to the input areas IA1 and IA3, and therefore the communicator 4 does not make the input areas IA1 and IA3 flash on and off.

Now, it is then determined whether the user has selected the command term CT42 in the selection area SA4 (S307). When the user selects the command term CT42, the communicator 4 makes the input area IA4 corresponding to the command term CT42 flash on and off (S308). In the same manner, when the user selects a command term CT63 or CT64 in the selection area SA6 (S309), the communicator 4 makes the input area IA6 flash on and off (S310).

By the above operation, the communicator 4 makes an input area IA corresponding to a command term selected by the user flash on and off, and notifies the user of the need to input a parameter to the area. In this way, the user can be prevented from being oblivious of the need to input a necessary parameter.

Determination Processing

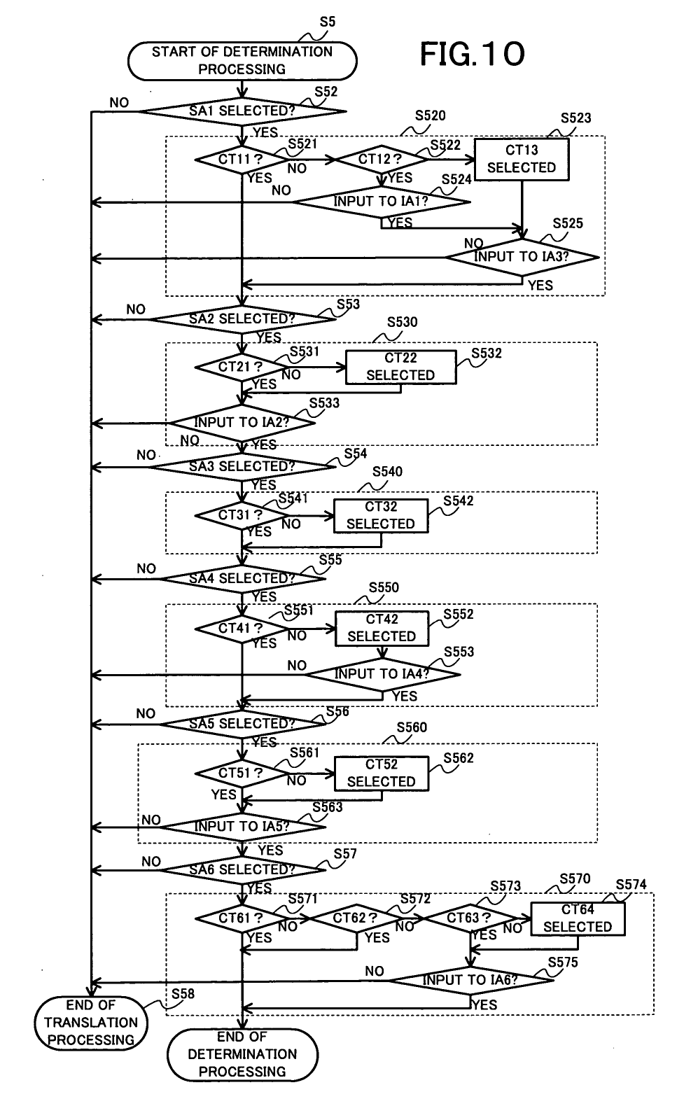

Referring to FIG. 10, the determiner 5 determines whether or not the user has selected a necessary command term CT in the plurality of selection areas SA1 to SA6 in the template TM3 (confirmation processing: S52 to S57). When a command term CT has been selected, the selected command term CT is specified. When there is an input area IA corresponding to the specified command term CT, it is then determined whether or not a parameter has been input in the input area IA (specifying processing: S520, S530, S540, S550, S560, S570).

Now, the determination processing will be described in detail. Note that the template TM3 for which the user has selected a command term CT and input a parameter is the same as that shown in FIG. 7.

To begin with, the determiner 5 carries out confirmation processing for the selection area SA1 in the template TM3, and determines whether or not a command term CT has been selected (S52). If no command term CT has been selected, the translation processing ends (S58).

Meanwhile, as a result of the determination in step S52, if a command term CT has been selected, the determiner 5 carries out specifying processing (S520). More specifically, the determiner 5 specifies which command term CT has been selected among the command terms CT11 to CT13 (S521 to S523). The determiner 5 specifies the command term CT12 (S512). Then, the determiner 5 determines whether or not a parameter has been input to the input areas IA1 and IA3 corresponding to the command term CT12 (S524, S525). Since “1000” has been input to the input area IA1, and “err1” has been input to the input area IA3, the determiner 5 determines that both input areas IA have been provided with a parameter, and the process proceeds to step S53. When no parameter has been input, the translation processing ends (S58).

Then, the determiner 5 carries out confirmation processing about the selection area SA2 (S53) and then specifying processing (S530). As a result of the specifying processing, the determiner 5 specifies a command term CT21 (S531), and determines that a parameter “sig1” has been input to the input area IA2 corresponding to the command term CT21 (S533). Note that if the command term CT21 is not specified, the determiner 5 specifies the selected command term as CT22 (S532).

In the same manner, the determiner 5 carries out confirmation processing about the selection area SA3 (S54) and then specifying processing (S540). More specifically, the determiner 5 specifies a command term CT31 (S541). Note that if the command term CT31 is not specified, the determiner 5 specifies the selected command term as CT32 (S542).

Then, the determiner 5 carries out confirmation processing about the selection area SA4 (S55) and then specifying processing (S550). As a result, the determiner 5 specifies the command term CT42 (S552), and determines whether or not a parameter has been input to the corresponding input area IA4. As can be seen from FIG. 7, the parameter “100” has been input to the input area IA4 (S553), the process proceeds to step S56. Note that if the determiner 5 specifies the command term CT41 in the specifying processing in step S550 (S551), the process directly proceeds to step S56.

In step S56, the determiner 5 carries out confirmation processing about the selection area SA5 (S56) and then specifying processing (S560). The determiner 5 specifies a command term CT51 (S561), and determines that a parameter “sig2” has been input to the input area IA5 (S563). Note that if a command term CT52 is specified (S562), the determiner 5 determines whether or not a parameter has been input to the input area IA5 (S563).

Then, the determiner 5 carries out confirmation processing about the selection area SA6 (S57) and then specifying processing (S570). At the time, the determiner 5 specifies which command term CT has been selected among the command terms CT61 to CT64 (S571 to S574). The determiner 5 specifies the command term CT63 (S573) and determines that “200” has been input to the input area IA6 corresponding to the command term CT63 (S575). Note that when the determiner 5 specifies the command term CT61 or CT62 (S571, S572), the determination processing ends at the point. If the command term CT64 has been selected (S574), it is determined whether a parameter has been input to the corresponding input area IA6 (S575).

By the above described operation, the determiner 5 specifies the selected command term CT, and determines whether a parameter has been input to an input area IA if there is any corresponding to the specified command term CT. When a necessary command term CT has not been selected or a necessary parameter has not been input, the translation processing ends (S58). Therefore, the user can readily determine whether or not a command term necessary for producing a statement has been selected or whether or not a necessary parameter has been input.

2. Second Embodiment

2.1. General Configuration

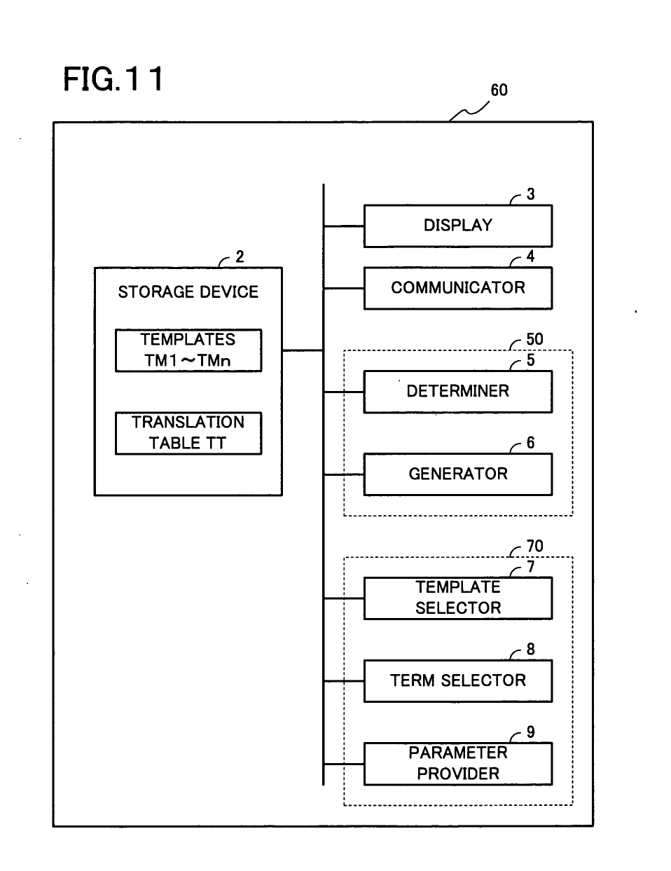

Referring to FIG. 11, an apparatus 60 additionally stores a translation table TT as in Table 1 in its storage device 2 when it is compared to the apparatus 1 shown in FIG. 1.

TABLE 1
6 translation table TT

| template | command code |
|---|---|
| TM1 | Inw |
| TM2 | . . . |
| TM3 | . . . |
| TM4 | Dlyw |
| — | |
| TMn | On |

Referring to Table 1, command codes corresponding to the templates TM1 to TMn are registered in the translation table TT.

The apparatus 60 further includes an inverse translation unit 70. The inverse translation unit 70 inverse-translates a statement in a source code into a natural language. The inverse translation unit 70 includes a template selector 7, a term selector 8, and a parameter provider 9.

The template selector 7 selects a template TMn corresponding to a command code in a statement selected from a source code displayed at the display 3 based on the translation table TT. The term selector 8 selects a command term CT corresponding to a command code in the selected statement in a selection area SA in the template TMn selected by the template selector 7. The parameter provider 9 provides a parameter for the selected statement in an input area IA corresponding to the command term CT selected by the term selector 8.

The other configuration is the same as that of the apparatus 1 shown in FIG. 1.

2.2. Inverse Translation

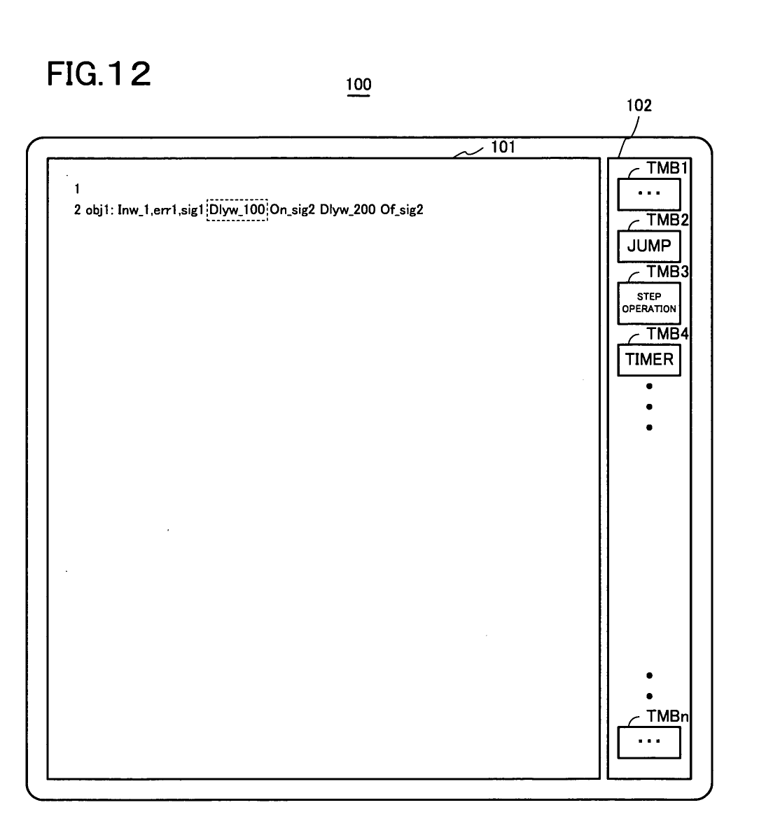

The operation of the apparatus 60 when the user selects the statement “Dlyw_{—}100” in the source code displayed in the source code display area 101 in FIG. 12 and inverse-translates the statement will be described.

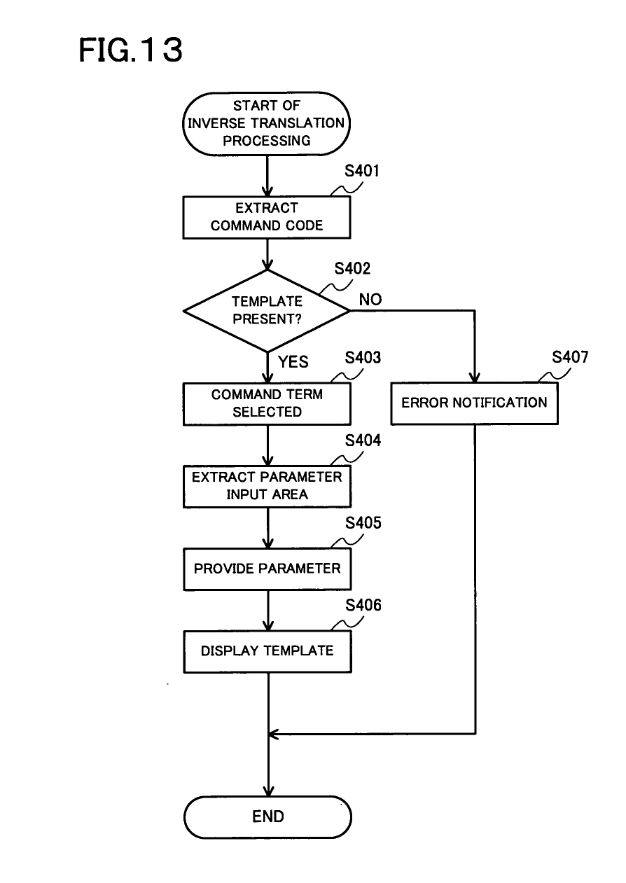

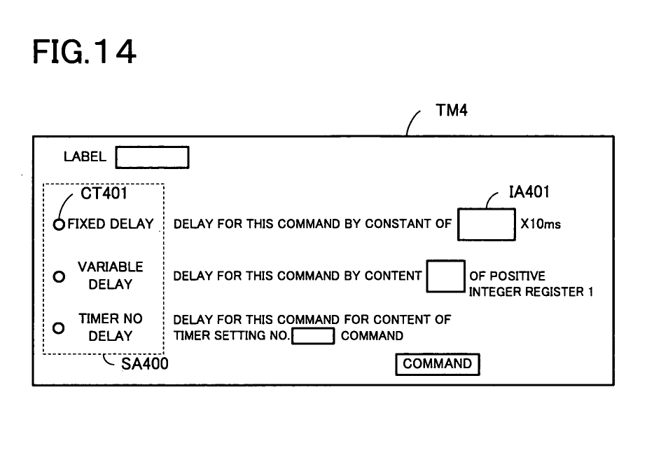

Referring to FIG. 13, the apparatus 60 extracts a command code from the selected statement (S401). More specifically, the apparatus selects the command code “Dlyw” from the statement “Dlyw_{—}100.” Then, the template selector 7 selects a template TMn corresponding to the command code “Dlyw” based on the translation table TT (S402). As can be seen from Table 1, the template TM4 corresponds to the command code “Dlyw” and therefore the template selector 7 selects the template TM4 shown in FIG. 14. Note that if the template selector 7 cannot select a template TMn corresponding to the command code in step S402, the apparatus 60 notifies the user of the error (S407). The error notification may be made by voice sounds or the error occurrence may be indicated at the display 3.

After the template selector 7 selects the template TM4 in step S402, the term selector 8 selects a command term CT401 corresponding to “Dlyw” in a selection area SA400 in the template TM4 (S403). Note that the command code and the command term correspond to each other and are previously registered in the storage device 2, so that the term selector 8 can select the command term CT401.

Then, the apparatus 60 extracts a parameter “100” from the statement “Dlyw_{—}100” (S404). The parameter provider 9 provides the extracted parameter “100” to the input area IA401 corresponding to the command term CT401 selected by the term selector 8 (S405). Note that the input area IA401 corresponds to the command term CT401, which is registered in the storage device 2.

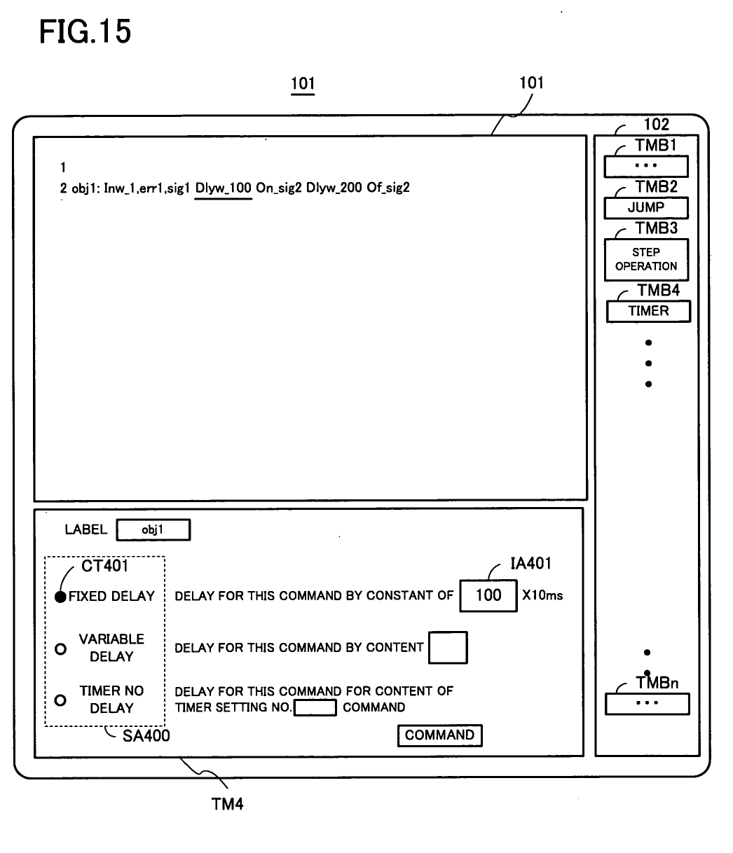

After the command term CT401 in the template TM4 is selected and the parameter “100” is provided in the input area IA401, the apparatus 60 displays the template TM4 at the display 3 (S406). An example of the screen image displayed in step S406 is shown in FIG. 15. In the shown template TM4, the command term CT401 has been selected and “100” has been input to the corresponding input area IA401.

By the above described operation, the apparatus 60 can inverse-translate the source code into a statement in a natural language. By the inverse translation operation, the statement in the source code “Dlyw_{—}100” is indicated in a natural language as “delay for a this command for a constant period of 100×10 ms.” As a result, the user can readily understand the meaning of the source code in terms of the natural language.

The embodiments of the invention in the foregoing are described simply by way of illustrating the present invention. Therefore, the invention is not limited to those embodiments described above and the embodiments may be modified as required without departing from the scope of the invention.

What is claimed is:

1. An apparatus for aiding in generating a source code including a plurality of statements comprising:
a storage device storing a plurality of templates corresponding to said plurality of statements, said plurality of templates each including a selection area having a plurality of command terms indicated in a natural language for generating said statement, a plurality of input areas to be provided with a parameter for generating said statement, and a command button to be selected by the user in producing the source code for said statement;
a display displaying a template selected by the user among said plurality of templates;
a determiner determining whether or not the user has selected a command term necessary for generating a desired statement in said selection area and input a necessary parameter for generating the desired statement to said input area when said command button in said displayed template is selected by said user; and
a generator generating the source code for said desired statement based on said selected command term and said input parameter when said determiner determines that said necessary command term has been selected and said necessary parameter has been input,
said display means displaying the source code generated by said generator.

2. The apparatus according to claim 1, wherein
said plurality of input areas correspond to said plurality of command terms, and
said determiner means determines whether or not a parameter has been input to the input area corresponding to the selected command term.

3. The apparatus according to claim 2, further comprising a communicator notifying the user of the need to input a parameter to the input area corresponding to a command term selected among a plurality of command terms in said selection area.

4. The apparatus according to claim 2, wherein
said plurality of statements include a plurality of command codes,
said plurality of command terms correspond to the plurality of command codes,
said storage device further stores a translation table having said plurality of command codes corresponding to said plurality of templates,
said apparatus further comprising:
a template selector selecting the template corresponding to said command code in the statement selected in the source code displayed at said display based on said translation table;
a term selector selecting the command term corresponding to said command code in the selection area in the selected template; and
a parameter provider providing a parameter in the selected statement to the input area corresponding to the selected command term,
after said term selector selects the command term, and the parameter provider provides the parameter, said display displaying the template selected by said template selector.

5. A program product for aiding in generating a source code including a plurality of statements, executable by a computer comprising a storage device storing a plurality of templates corresponding to said plurality of statements,
said plurality of templates each including:
a selection area having a plurality of command terms indicated in a natural language for generating said statement;
a plurality of input areas to be provided with a parameter for generating said statement; and
a command button selected by the user for enabling said computer to generate the source code for said statement,
said program product for enabling said computer to execute the steps of:
displaying a template selected among said plurality of templates at a display for said computer;
determining whether or not a necessary command term for generating a desired statement has been selected in the selection area and a necessary parameter for generating the desired statement has been input to the input area when said command button in the displayed template is selected;
generating the source code for the desired statement based on the selected command term and input parameter when said determiner determines that the necessary command term has been selected and the necessary parameter has been input; and
displaying the generated source code at said display.

6. An apparatus for translating a source code made of a plurality of statements into a natural language, said plurality of statements including a plurality of command codes, said apparatus comprising:
a storage device storing a plurality of templates and a translation table having said plurality of command codes corresponding to said plurality of templates each including a selection area having a plurality of command terms indicated in a natural language and corresponding to said plurality of command codes, and a plurality of input areas for indicating parameters corresponding to said plurality of command terms;
a display displaying the source code;
a template selector selecting the template corresponding to the command code in the statement selected in the source code based on said translation table;
a term selector selecting the command term corresponding to the command code in the selection area in the selected template; and
a parameter provider providing a parameter in the selected statement to the input area corresponding to the selected command term,
said display displaying the template selected by said template selector after said term selector selects the command term and said parameter provider provides the parameter.
